(19) United States
(12) Patent Application Publication
(10) Pub. No.: US 2018/0037823 A1
(43) Pub. Date: Feb. 8, 2018

(54) MANUFACTURING APPARATUS AND METHOD FOR FUEL HYDROCARBON

(71) Applicant: BIO HITECH ENERGY CO., CHESTNUT RIDGE, NY (US)

(72) Inventors: JAMES CHUN KOH, FORT LEE, NJ (US); TADASHI TAKEMOTO, KUSATU-SHI (JP)

(73) Assignee: BIO HITECH ENERGY CO., CHESTNUT RIDGE, NY (US)

(21) Appl. No.: 15/226,343

(22) Filed: Aug. 2, 2016

(51) Int. Cl. C10G 2/00; B01J 19/24; B01J 19/12

(52) U.S. Cl. CPC C10G 2/30; C10G 2/50; B01J 19/123; B01J 19/24; C10G 2300/4081; B01J 2219/0877; B01J 2219/0869; B01J 2219/24; B01J 2219/1203

(57) ABSTRACT

There is provided a fuel hydrocarbon manufacturing apparatus, including a water treatment tank configured to create activated water; a plurality of quartz tubes configured to contain titanium oxide coated ceramics; a plurality of UV lamp; a water tank configured to receive activated water from the water treatment tank; an oil tank configured to contain original oil; a inline mixer configured to break down water and oil into very small clusters and mix together to form an emulsified mixture; a emulsion tank; a reactor tank configured to produce new oil; a water-oil separator configured to divide new oil from remaining water; and a return conduit configured to supply new oil back to the oil tank.

### FIELD OF THE INVENTION

The various embodiments described herein pertain generally to an apparatus and method for manufacturing fuel hydrocarbon.

### BACKGROUND OF THE INVENTION

The origin of petroleum oil on earth has been mainly introduced by the theory of biotic hypothesis. On the other hand, the abiotic theory that the oil could be formed at high temperature and pressure from inorganic carbon in the form of carbon dioxide with hydrogen or methane has not been considered feasible due to the lack of direct evidence to date since its first introduction in 1967.

Japanese Patent Laid-open Publication No. 2011-03800 (titled “Fuel Manufacturing Method”) describes a method and apparatus for manufacturing an emersion fuel that can be atomized and exhibits high applicability and high stability. In this method and apparatus, water and an oil fuel such as diesel, kerosene or heavy oil are supplied into a space to which a magnetic field is applied. In that space, the water and the oil fuel are atomized and mixed with each other, so that an emersion fuel is produced.

In such a conventional fuel manufacturing method and apparatus, however, since the fuel is in the form of emersion, water-oil separation may occur and a water component may be left. As a consequence, a flash point would be greatly increased, whereas a calorific power would be decreased, resulting in a failure to reduce the consumption of the fossil fuel greatly.

The present inventor has previously filed US patent application US 20140305028 A1 (titled “Apparatus for Manufacturing a Reformed Fuel and a Method for Manufacturing the Same”). In this method and apparatus, water is atomized by applying an ultrasonic wave or an electric field to a water tank, and hydrogen peroxide is decomposed by supplying enzyme from an enzyme tank. Accordingly, water and oil are allowed to be easily mixed with each other without separated. Thus, it is possible to suppress the aforementioned problems of the reformed fuel in the form of emersion, such as an increase of a flash point and a decrease of a calorific power.

These conventional apparatus and method for manufacturing a reformed fuel involves a complicated process, and there is difficulty in managing enzyme in the enzyme tank. Further, since the apparatus has a complicated structure adapted to apply the ultrasonic wave and the electric field, manufacturing cost is high and repair and maintenance of the apparatus is not easy.

### SUMMARY

In view of the foregoing problems, example embodiments provide an effective way to produce a fuel hydrocarbon through the multiple process of reactions from carbon dioxide and activated water at normal temperatures and pressures.

In accordance with the first aspect of the illustrative embodiment, there is provided a fuel hydrocarbon manufacturing apparatus including a water treatment tank configured to receive purified water from a water source and create an activated water; a nano-bubble generator submerged in the water inside the water treatment tank to provide nano-bubble to the water; a first carbon dioxide generator configured to generate carbon dioxide gas and provide carbon dioxide gas to the water through the nano-bubble generator inside the water treatment tank; an oxygen generator configured to generate oxygen gas and provide oxygen gas to the water inside the water treatment tank; a plurality of quartz tubes configured to contain titanium oxide coated ceramics therein; a plurality of UV lamp configured to provide UV light to the plurality of quartz tubes; a water feeding pump configured to circulate the water inside the water treatment tank to the plurality of quartz tubes; a water tank configured to receive activated water from the water treatment tank; an oil tank configured to contain original oil; a inline mixer configured to break down the activated water and original oil into very small clusters and mix together to form an emulsified mixture; a emulsion tank configured to contain the emulsified mixture; a reactor tank configured to receive the emulsified mixture from the emulsion tank fed by an emulsion feeding pump, to agitate the emulsified mixture vigorously, and finally to produce new oil; a water-oil separator configured to divide new oil from remaining water; and a return conduit configured to supply new oil back to the oil tank to repeat the reaction process and increase the production rate.

In accordance with the second aspect of an illustrative embodiment, there is provided a fuel hydrocarbon manufacturing apparatus including a water treatment tank configured to receive purified water from a water source; a nano-bubble generator submerged in the water inside the water treatment tank to provide nano-bubble to the water; an oxygen generator configured to generate oxygen gas and provide oxygen gas to the water inside the water treatment tank; a plurality of quartz tubes configured to contain titanium oxide coated ceramics; a plurality of UV lamp configured to provide UV light to the titanium oxide coated ceramics inside the plurality of quartz tubes; a water feeding pump configured to circulate the water inside the water treatment tank to the plurality of quartz tubes to generate activated water; a water tank configured to receive activated water from the water treatment tank; an oil tank configured to contain original oil; a inline mixer configured to break down water and oil into very small clusters and mix together to form an emulsified mixture; a emulsion tank configured to contain the emulsified mixture; a second carbon dioxide generator configured to generate carbon dioxide gas and provide carbon dioxide gas to the emulsion tank through the line mixer; a reactor tank configured to be initially filled with carbon dioxide inside from a third carbon dioxide generator, to receive the emulsified mixture from the emulsion tank fed by an emulsion feeding pump, to agitate the emulsified mixture vigorously, and finally to produce new oil; a water-oil separator configured to divide new oil from remaining water; and a return conduit configured to supply new oil back to the oil tank to repeat the reaction process and increase the production rate.

In accordance with the illustrative embodiments, new oil is separated from remaining water using the water-oil separator. The volume of new oil after separation is increased by 8%-12% from the original oil depending on the type of oil used.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 is a plane view of a fuel hydrocarbon manufacturing apparatus in accordance with an example embodiment;

FIG. 2 is a side view of a fuel hydrocarbon manufacturing apparatus in accordance with the example embodiment;

FIG. 3 (a) is a schematic diagram for describing functions of a water treatment tank and a plurality of quartz tube in accordance with the example embodiment;

FIG. 3 (b) is a schematic diagram for describing functions of a water tank, oil tank, and line mixer in accordance with the example embodiment;

FIG. 3 (c) is a schematic diagram for describing functions of an emulsion tank and a reactor tank in accordance with the example embodiment;

FIG. 3 (d) is a schematic diagram for describing functions of a water-oil separator and a return conduit in accordance with the example embodiment;

FIG. 4 is a schematic diagram for describing a water tank in accordance with the example embodiment;

FIG. 5 is a schematic diagram for describing an oil tank in accordance with the example embodiment;

FIG. 6 is a schematic diagram for describing a reactor tank in accordance with the example embodiment;

FIG. 7 is a schematic diagram for describing a water-oil separator in accordance with the example embodiment;

### DETAILED DESCRIPTION

Hereinafter, example embodiments will be described in detail so that inventive concept may be readily implemented by those skilled in the art. However, it is to be noted that the present disclosure is not limited to the illustrative embodiments and examples but can be realized in various other ways. In drawings, parts not directly relevant to the description are omitted to enhance the clarity of the drawings, and like reference numerals denote like parts through the whole document.

Through the whole document, the term “on” that is used to designate a position of one element with respect to another element includes both a case that the one element is adjacent to the another element and a case that any other element exists between these two elements.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise. The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Hereinafter, the example embodiment will be described in detail with reference to the accompanying drawings, which form a part hereof.

First, a fuel hydrocarbon manufacturing apparatus 10 (hereinafter, referred to as “the present fuel manufacturing apparatus 10”) in accordance with an example embodiment will be elaborated.

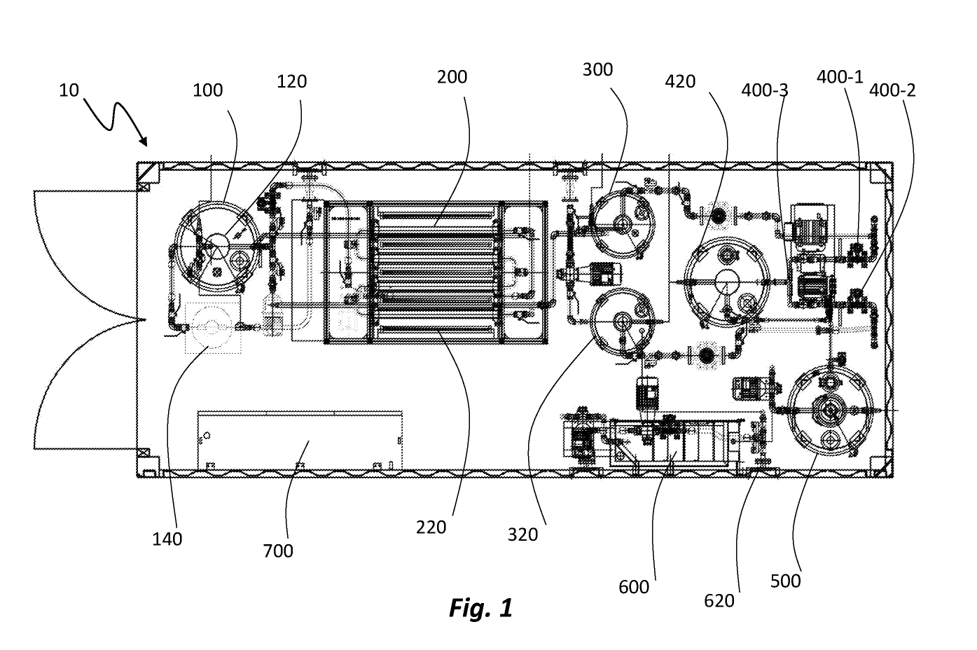

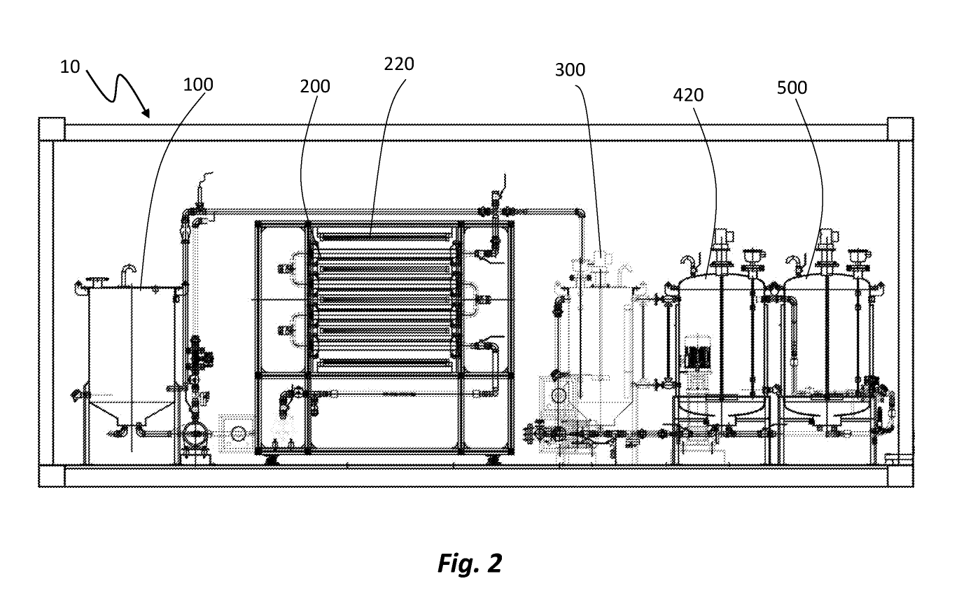

Referring to FIG. 1 and FIG. 2, a configuration of the present fuel manufacturing apparatus 10 will be explained.

As depicted in FIG. 1 and FIG. 2, the present fuel manufacturing apparatus 10 includes a water treatment tank 100, a nano-bubble generator 120, an oxygen generator 140, a plurality of quartz tubes 200, a plurality of UV lamps 220, a water tank 300, an oil tank 320, a inline mixer 400-1, 400-2, 400-3, an emulsion tank 420, a reactor tank a mixing tank 500, a water-oil separator 600 and a return conduit 620.

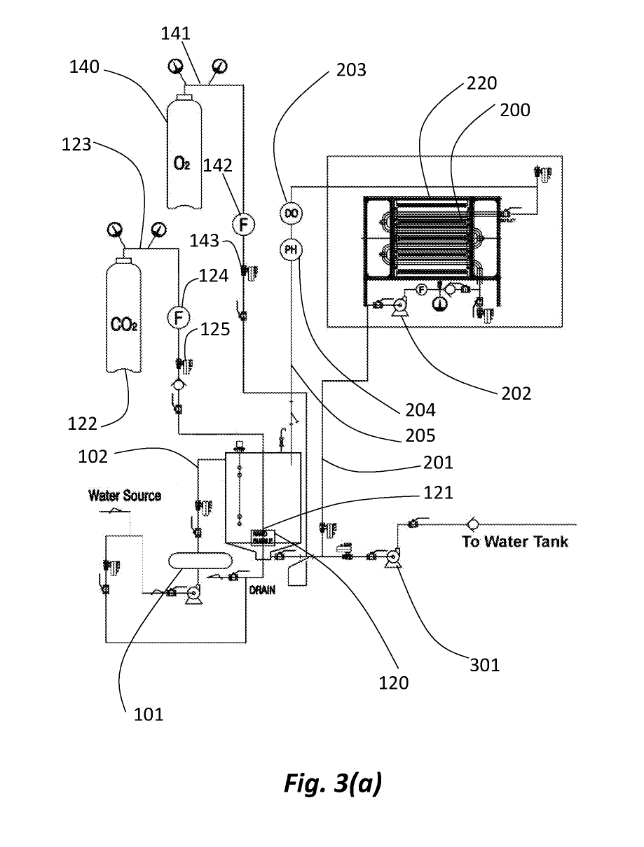

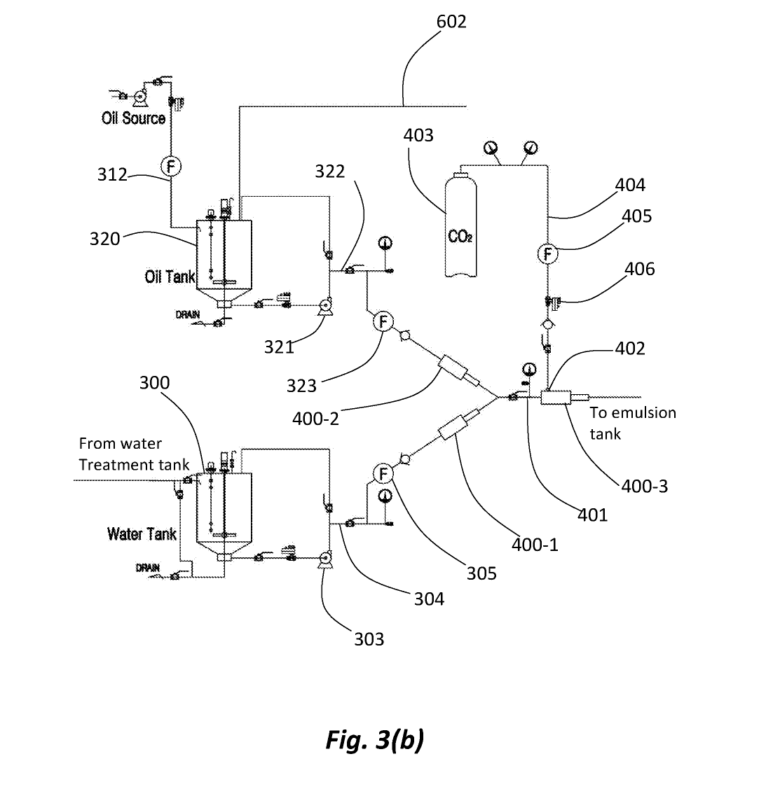

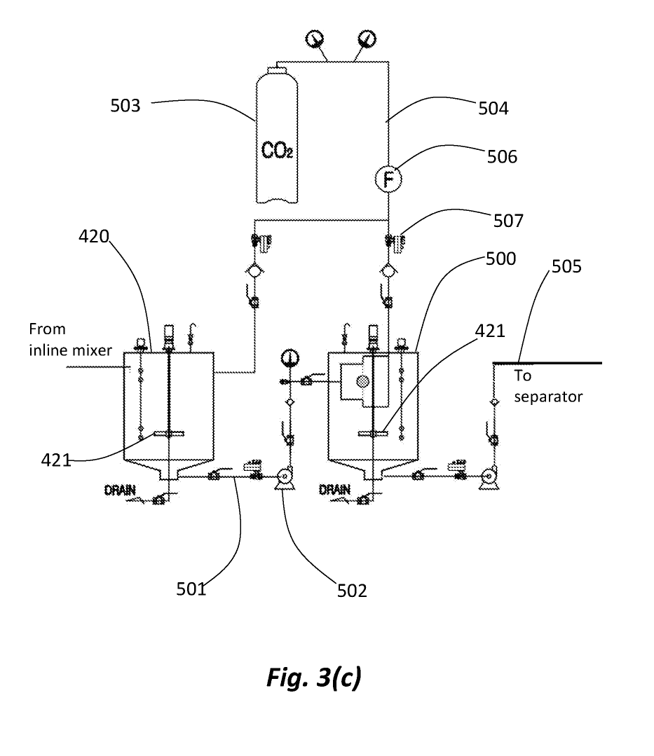

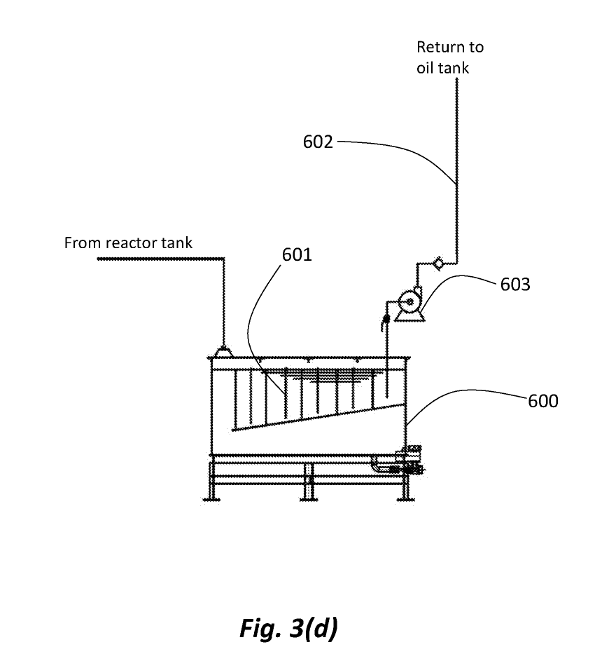

Referring to FIG. 3(a), the water treatment tank 100, the nano-bubble generator 120, the oxygen generator 140, the plurality of quartz tubes 200, the plurality of UV lamps 220, in accordance with the example embodiment will be elaborated in further detail.

The water treatment tank 100 contains water initially received from outside water source. The water is preferably treated by a reverse osmosis purifier 101 and the minerals dissolved in the water are removed before entering to the water treatment tank 100.

Also, the purified water by reverse osmosis purifier 101 is supplied to the water treatment tank 100 through a water inlet line 102.

The nano-bubble generator 120 is configured inside the water treatment tank 100. Submerged in the water, the nano-bubble generator 120 supplies nano-sized bubble to the water inside the water treatment tank 100.

The nano-bubble generator 120 accommodates a carbon dioxide inlet port 121. A first carbon dioxide generator 122 is connected to the carbon dioxide inlet port 121 through a carbon dioxide line 123. When the nano-bubble generator 120 provides bubbles inside the water, the carbon dioxide gas is infused in the water simultaneously so that the pH level of the water becomes in the range of 4-5.

The carbon dioxide line 123 is equipped with a carbon dioxide gas flowmeter 124 and a carbon dioxide gas control valve 125 to monitor the amount of carbon dioxide gas to the water treatment tank 100. The digital signal from the carbon dioxide gas flowmeter 124 may be used in a controller 700 and the carbon dioxide gas control valve 125 is operated by the controller 700 to adjust the amount of carbon dioxide gas. The amount of carbon dioxide gas from the first carbon dioxide generator 122 is set to 400 ml/min for about 30 minutes. The controller is composed of programmable logic diagram (PLC) blocks with A/D and D/A converters to receive signals from the sensors and to send signals to the valves, motor and pumps.

The oxygen generator 140 is configured to generate oxygen gas and provide the oxygen gas to the water treatment tank 100 through an oxygen gas supply line 141. The oxygen gas supply line 141 is equipped with an oxygen gas flowmeter 142 and an oxygen gas control valve 143 to monitor the amount of oxygen gas to the water treatment tank 100. The amount of oxygen gas from the oxygen generator 140 is set to 200 ml/min until activated water is created.

The plurality of quartz tubes 200 are connected to the water treatment tank 100 through the water input line 201. The water inside the water treatment tank 200 circulates the plurality of quartz tubes 200 using a water feeding pump 202. Titanium dioxide coated ceramic particles are filled inside the plurality of quartz tubes 200. A plurality of UV lamps 220 irradiate UV lights directly onto the titanium dioxide. When the nano-bubble and oxygen gas containing water passes through titanium oxide particles, oxygen gas inside the water is converted to ozone and reactive oxygen species such as superoxide anion radicals and hydroxyl radicals with UV light irradiation to titanium oxide. A dissolved oxygen (DO) meter 203 and a pH meter 204 are equipped on the water feedback line 205. The water circulates from the water treatment tank 100 to the plurality of quartz tubes 200 until the measurement of DO to be about 27-33 ppm and pH to be about 4.0-5.0.

To increase reaction surface between the water and titanium dioxide ceramics, the plurality of titanium dioxide tubes are connected in series. In this embodiment, the one meter long quartz tube has been used and twenty of the tube have been connected in series.

The plurality of UV light lamps may be inserted at the center of inside the plurality of quartz tubes respectively. This configuration will give UV light in 360 degree direction to effectively utilize the UV source.

Referring to FIG. 3(b), the water tank 300, the oil tank 320 and the line mixer 400 in accordance with the example embodiment will be elaborated in further detail.

The water inside the water treatment tank 100 becomes an activated water after circulating through the plurality of quartz tubes 200 and being treated by titanium oxide and UV light. Then the activated water is fed to the water tank 300 using an activated water feeding pump 301.

The oil tank 320 contains the original oil from outside oil source through the oil line 312. The exemplary oil type is possibly kerosene, light oil, and diesel fuel.

The activated water from the water tank 300 is directed into a water mixing pump 303 after passing through an activated water input line 304. The water flowmeter 305 is configured to measure a flow rate of the water. That is, the activated water input line 304 is equipped with the water flowmeter 305 capable of measuring the flow rate of the activated water coming from the water tank 200.

The oil from the oil tank 320 is directed into an oil mixing pump 321 after passing through an oil input line 322. An oil flowmeter 323 is configured to measure a flow rate of the oil. That is, the oil input line 322 is equipped with the oil flowmeter 323 capable of measuring a flow rate of the pretreated oil coming from the oil tank 320.

The water flowmeter 305 and the oil flowmeter 323 measure the flow rate of the activated water and the flow rate of the oil supplied into an emulsion tank 420, respectively. Further, the main controller 700 may adjust a ratio between the activated water and the oil through the use of a value or the like based on measurements of the water flowmeter 305 and the oil flowmeter 323.

Desirably, a ratio between an inflow rate of the activated water and an inflow rate of the oil supplied into the emulsion tank 420 may be about 1:1.

The activated water input line 304 includes an inline water mixer 400-1 having a multiple number of protrusions on an inner surface thereof in order to produce turbulence in the water passing through the activated water input line 304. Through this turbulence, water molecules passing through the inline water mixer 400-1 are allowed to have greater movement.

The oil input line 322 includes an inline oil mixer 400-2 having a multiple number of protrusions on an inner surface thereof in order to produce turbulence in the oil passing through the oil input line 322. Through this turbulence, oil molecules passing through the inline oil mixer 400-2 are allowed to have greater movement.

The activated water input line 304 and the oil input line 322 join to a water-oil mixture line 401 as a single line. The water-oil mixture line 401 includes an inline water-oil mixer 400-3 that generates turbulences in the water and the oil passing through the water-oil mixture line 401. The inline water-oil mixer 400-3 may have a multiple number of protrusions on an inner surface thereof. That is, the activated water and the oil that meet in the water-oil mixture line 401 are physically mixed again effectively while they pass through the inline water-oil mixer 400-3 and become an emulsified mixture.

The inline water-oil mixer 400-3 accommodates a carbon dioxide inlet port 402. A second carbon dioxide generator 403 is connected to the carbon dioxide inlet port 402 through a carbon dioxide line 404 to provide carbon dioxide gas into the water-oil mixture. When the water-oil mixture passes through the inline water-oil mixer 400-3, the flow of water-oil mixture forms a backpressure on the carbon dioxide line 404 and the carbon dioxide gas is automatically drawn into the emulsified mixture by suction from the second carbon dioxide generator 403.

The carbon dioxide line 404 is equipped with a carbon dioxide gas flowmeter 405 and a carbon dioxide gas control valve 406 to monitor the amount of carbon dioxide gas to the inline water-oil mixer 400-3.

Referring to FIG. 3(c), the emulsion tank 420 and the reactor tank 500 in accordance with the example embodiment will be elaborated in further detail.

The emulsion tank 420 receives and holds the emulsified mixture that is formed by inline mixer 400-1, 400-2, 400-3. The emulsion tank 420 is configured to agitate the emulsified mixture therein using an agitator 421 specially designed to break down the emulsified mixture further in a very small clusters to maintain the mixture in emulsion status.

The reactor tank 500 accommodates a carbon dioxide inlet port 509. A third carbon dioxide generator 503 is connected to the carbon dioxide inlet port 509 through a carbon dioxide line 504 to provide carbon dioxide gas into the reactor tank 500.

The reactor tank 500 is previously filled with carbon dioxide gas through a third carbon dioxide generator 503 with the inside pressure of the reactor tank 500 to be 0.4-1.0 MPa, before the emulsified mixture comes inside.

The reactor tank 500 is connected to the emulsion tank 420 through an emulsion line 501. An emulsion feeding pump 502 is installed on the emulsion line 501 and feeds the emulsified mixture from the emulsion tank 420 to the reactor tank 500. The pressure of the emulsion feeding pump 502 is preferably set to 7.0-8.0 MPa.

The agitator 421 that is same kind used in the emulsion tank 420 is also attached at the center of inside the reactor tank 500 and rotates vigorously for about 4-5 minutes during the reaction between the emulsified mixture and carbon dioxide gas therein, thus finally produces new oil that is increased about 8-12% by the volume from the original amount of oil. During the reaction process which is about 4 minutes, carbon dioxide gas is continuously provided from the third carbon dioxide generator 503.

Referring to FIG. 3(d), the water-oil separator 600 and a return conduit 620 in accordance with the example embodiment will be elaborated in further detail.

The water-oil separator 600 contains a plurality of vertical layers 601 of which the bottom is slotted to open alternatively so that the new oil passes from one vertical slot to another. When the new oil is filled up two vertical layer chambers, then it will pass over the top of the layer and goes to next layer chamber. In doing so, a remaining water that is not processed during the reaction and remained redundant is being separated from the newly oil by the difference of the specific gravity of the new oil and the remaining water and collected at the bottom of the layer.

Once the remaining water is separated from the new oil by the water-oil separator 600, the only new oil portion that is formed upper side of the separator 600 is transferred back to the oil tank 320 described in FIG. 3(b). When the new oil goes back to the oil tank 320 through a feedback line 602 using an oil feedback pump 603 and undergoes the fuel hydrocarbon manufacturing process, the volume of newly generated is increased, about another 8-10% again. This repetition process is possibly performed upto three times and total volume will be ended up to 25-30% increase based on the amount of original oil.

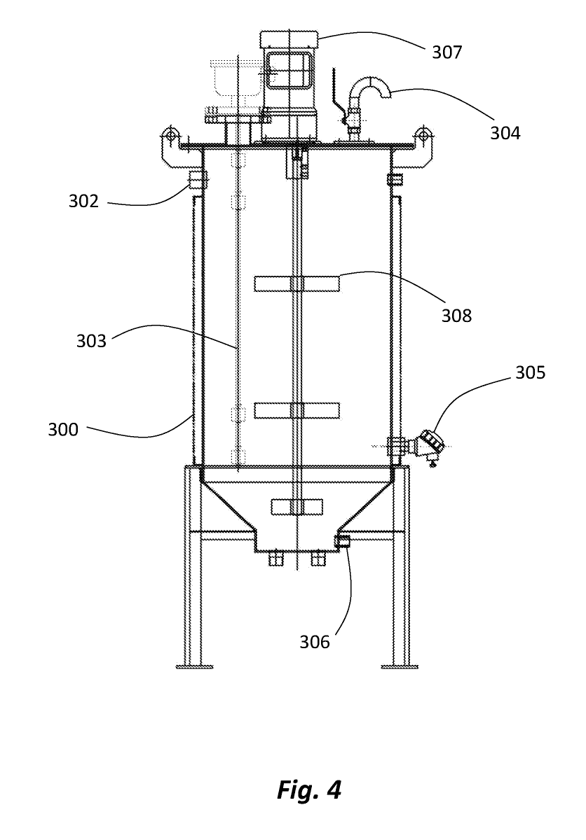

Referring to FIG. 4, the water tank 300 in accordance with the example embodiment will be elaborated in further detail.

The water tank 300 contains water received from the water treatment tank 100 through the water inlet line 301 and a water inlet port 302. A water level indicator 303 is attached on the side of the water tank 300 so that the amount of water inside is easily monitored from outside visually. An air vent 304 is installed on the top and center of the water tank 300 to prevent any pressure buildup due to the water input. A water temperature sensor 305 is attached on the side of the tank and constantly measure the temperature inside through the main controller 700. The temperature should be maintained about 20-25 degree Celsius during the operation. A water drain port 306 is formed at the bottom of the water tank 300 to empty the tank in a certain case. A water tank motor 307 is vertically installed on the top of the tank and slowly agitates the water inside using a water agitating blade 308.

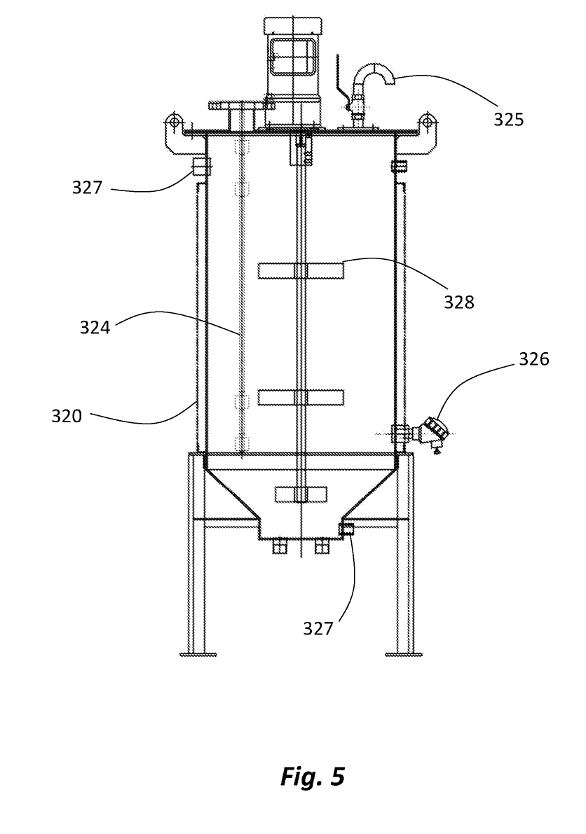

Referring to FIG. 5, the oil tank 320 in accordance with the example embodiment will be elaborated in further detail.

The oil tank 320 contains oil received from the outside oil source through the oil line 312 and an oil inlet port 321. An oil level indicator 324 is attached on the side of the oil tank 320 so that the amount of oil inside is easily monitored visually. An air vent 325 is installed on the top of the oil tank 320 to prevent any pressure buildup due to the oil input. An oil temperature sensor 326 is attached on the side of the tank and constantly measure the temperature inside through the main controller 700. The temperature should be maintained in the range of 25-30 degree Celsius during the operation. An oil drain port 327 is formed at the bottom of the oil tank 320 to empty the tank in a certain case. An oil tank motor 328 is vertically installed on the top and center of the tank and slowly agitates the oil inside using an oil agitating blade 328.

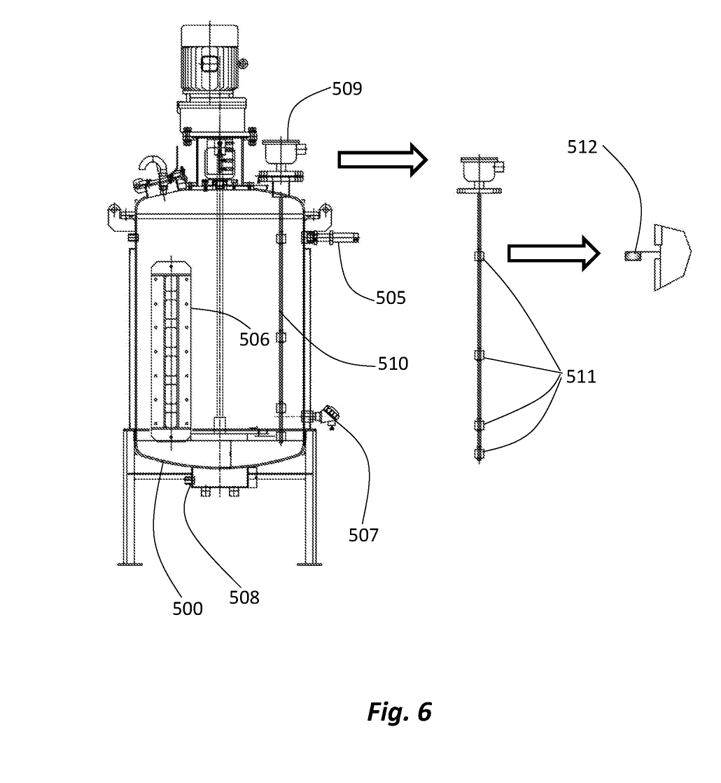

Referring to FIG. 6, the reactor tank 500 in accordance with the example embodiment will be elaborated in further detail.

The reactor tank 500 receives and holds the emulsified mixture from the emulsion tank 420 through the emulsion line 502 and an emulsion inlet port 505.

Inside the reactor tank 500, carbon dioxide gas is filled using the third carbon dioxide generator 503 with the pressure of 0.4-1.0 MPa through a carbon dioxide line 504, before the water-oil mixture comes inside.

The carbon dioxide line 504 is connected to a carbon dioxide inlet port 509 installed on the top of the reactor tank 500. A carbon dioxide spraying rod 510 is vertically connected to the carbon dioxide inlet port 509 and extruded inside the reactor tank 500. A plurality of spraying nodes 511 are located along the carbon dioxide spraying rod 510. A plurality of spraying nozzles 512 are attached onto the plurality of spraying nodes 511 individually. The size of the plurality of spraying nozzles 512 are preferably less than 2 mm diameter. During the reaction process, carbon dioxide gas is continuously provided inside the reactor tank 500 through the plurality of spraying nozzles 512 with a great turbulences so that the emulsified mixture and carbon dioxide gas react each other more efficiently.

The temperature of the reactor tank should be maintained in the range of 30-33 degree Celsius inside the reactor tank 500. A heating pad 506 is attached on the side of the reactor tank 500 to maintain desired temperature constantly. An emulsion temperature sensor 507 is attached on the side of the tank and constantly measure the temperature inside using the controller 700 then turn on and off the heating pad 506 to satisfy the required temperature. An emulsion drain port 508 is formed at the bottom of the reactor tank 500 to empty the tank in a certain case.

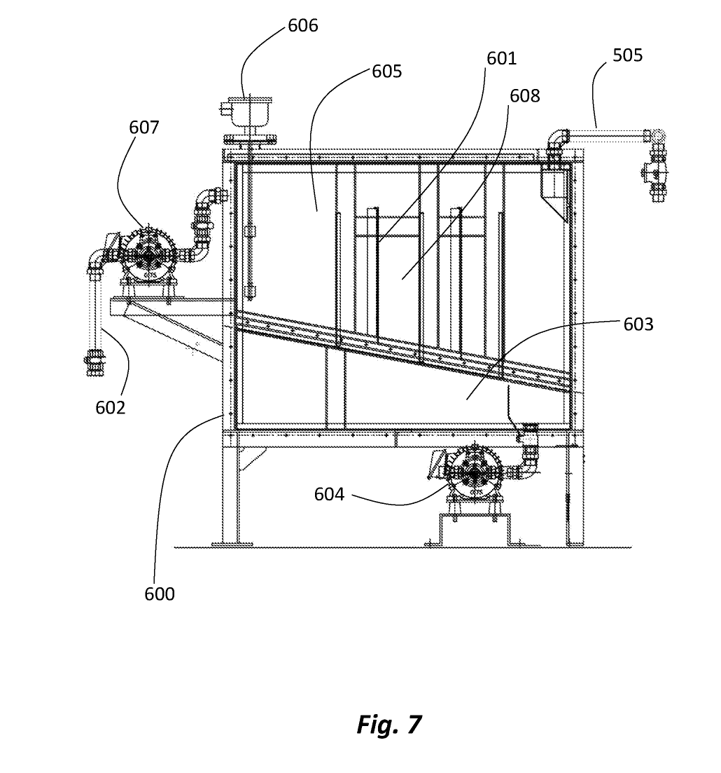

Referring to FIG. 7, the water-oil separator 600 and the return conduit 620 in accordance with the example embodiment will be elaborated in further detail.

The water-oil separator 600 contains a plurality of vertical layers 601 and a plurality of layer chamber 608 of which the bottom is slotted to open alternatively so that the new oil passes from one vertical slot to another. When the new oil is filled up two vertical layer chamber, then it will pass over the top of the layer and goes to next layer chamber. In doing so, the remaining water that is not processed during the reaction is being separated from the newly oil by the difference of the specific gravity and collected at the bottom of the layer chamber 608.

A water chamber 604 formed at the bottom of the water-oil separator 600 collects the remaining water from the new oil and is drained out to the sewage system through a drain pump 604. An oil chamber 605 forma at the top or the water-oil separator 600 collects the new oil. When a new oil sensor 606 detects the amount of new oil, an oil return pump 607 feed the new oil back to the oil tank through the feedback line 602.

### Exemplary Method for Embodiment

Now, a method for manufacturing fuel hydrocarbon in accordance with the present example embodiment (hereinafter, simply referred to as “the present reformed fuel manufacturing method”) will be elaborated. The method is directed to manufacturing a fuel hydrocarbon by using the present apparatus as described above. Parts identical or similar to those described in the present fuel hydrocarbon apparatus will be assigned same reference numerals, and redundant description will be simplified or omitted.

The present fuel hydrocarbon manufacturing method is preparing the activated water by providing purified water into the water treatment tank 100; supplying nano-bubble carbon dioxide gas into the water inside the water treatment tank 100; supplying oxygen gas into the water inside the water treatment tank 100; circulating the water to the titanium dioxide coated ceramics irradiated by UV light.

At this moment, carbon dioxide gas is generated by the first carbon dioxide generator 122 and oxygen gas is generated by the oxygen gas generator.

The next procedure for the present fuel hydrocarbon manufacturing method is storing the activated water in the water tank 300, storing the oil in the oil tank 320, supplying the activated water and the oil to the inline water mixer 400-1 and the inline oil mixer 400-2 individually to create the emulsified mixture and supplying carbon dioxide gas through the inline water-oil mixer 400-3.

The activated water input line 304 includes an inline water mixer 400-1 having a multiple number of protrusions on an inner surface thereof in order to produce turbulence in the water passing through the activated water input line 304. The oil input line 322 includes an inline oil mixer 400-2 having a multiple number of protrusions on an inner surface thereof in order to produce turbulence in the oil passing through the oil input line 322. The activated water input line 304 and the oil input line 322 join to a water-oil mixture line 401 as a single line. The water-oil mixture line 401 includes an inline water-oil mixer 400-3 that generates turbulences in the water and the oil passing through the water-oil mixture line 401. At this moment, carbon dioxide gas is generated by the second carbon dioxide generator 403.

The next procedure for the present fuel hydrocarbon manufacturing method is storing the water-oil mixture to the emulsion tank 420, preparing carbon dioxide gas inside the reactor tank 500, supplying emulsified mixture to the reactor tank 500 using the emulsion feeding pump 502, and agitating the emulsified mixture inside the reactor tank 500.

At this moment, carbon dioxide gas is generated by the third carbon dioxide generator 503.

The next procedure for the present fuel hydrocarbon manufacturing method is separating the new oil from the remaining water by the water-oil separator 601, returning the new oil to the oil tank 320, and repeating the fuel hydrocarbon manufacturing process to increase the volume of output.

### Test Results of Embodiment

The principle of manufacturing fuel hydrocarbon from activated water and carbon dioxide will be discussed herein more in detail.

When the water from the water treatment tank 100 circulates the plurality of quartz tubes, oxygen gas provided by the oxygen generator 140 is converted to ozone through titanium dioxide and UV light. Oxygen gas is further converted to reactive oxygen species such as superoxide anion radicals and hydroxyl radicals. The reactive oxygen species reduces carbon dioxide to carbon monoxide and hydrogen gas,

CO₂+H₂O<=>CO+H₂+O₂ (Process 1)

The activated water and oil are collide each other and mixed together using inline mixer, forming emulsified water-oil mixture. In the reactor tank, the water-oil mixture and carbon dioxide gas undergo chemical reaction at room temperature, more specifically 30 degree Celsius, and normal pressure. The new oil will be produced as radical emulsion polymerization in micelles as follows,

nCO+(2n+1)H₂<=>CₙH₂ₙ₊₂+nH₂O (Process 2)

This reaction is a part of Fischer-Tropsch process and it is normally performed in the high temperature and high pressure. Whereas, the present invention discloses that the fuel hydrocarbon is possibly generated through the reaction of carbon dioxide and activated water using titanium dioxide and UV light. The final chemical expression of the reaction may be described as follows by combining process 1 and 2.

nCO₂+(n+1)H₂<=>CₙH₂ₙ₊₂+nO₂

After collecting the final product from the present embodiment, the analysis of the original and new oil has been performed and each of the chemical and mechanical properties compared accordingly. The diesel oil has been used at this experiment. The table 1 represents all the property values. The quality of new oil is identical and reveals equivalent performances to satisfy the fuel grade requirement and regulation.

TABLE 1
Comparison of original and new oil

| | | Result | | |
|---|---|---|---|---|
| Item | Unit | Original oil | New oil | Test method |
| Flash point | ° C. | 73.0 | 82.0 | JIS K2265-3 |
| Dynamic viscosity | mm²/s | 3.479 | 3.710 | JIS K2283 |
| Pour point | ° C. | −15.0 | −12.5 | JIS K2269 |
| Remained Carbon | Mass % | 0.01 | 0.04 | JIS K2270-2 |
| Water, KF Method | Mass % | 0.0063 | 0.010 | JIS K2272 |
| Sulfur | Mass % | 0.00007 | 0.00007 | JIS K2541-6 |
| Density (15° C.) | g/cm³ | 0.8295 | 0.8311 | JIS K2249-1 |
| Cetane Number | | 56.2 | 56.9 | JIS K2280-5 |
| Calorific value | J/g | 45990 | 46010 | JIK K2279 |

The above description of the illustrative embodiments is provided for the purpose of illustration, and it would be understood by those skilled in the art that various changes and modifications may be made without changing technical conception and essential features of the illustrative embodiments. Thus, it is clear that the above-described illustrative embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

What is claimed is:

1. A fuel hydrocarbon manufacturing apparatus, comprising:
a water treatment tank configured to generate an activated water;
a plurality of quartz tubes configured to contain titanium oxide coated ceramics therein;
a plurality of UV lamp configured to provide UV light to titanium oxide coated ceramics inside the plurality of quartz tubes;
a water feeding pump configured to circulate water inside the water treatment tank to the plurality of quartz tubes;
a water tank configured to receive the activated water from the water treatment tank;
an oil tank configured to contain original oil;
a inline mixer configured to break down the activated water and original oil into very small clusters and mix together to form an emulsified mixture;
a emulsion tank configured to contain the emulsified mixture;
a reactor tank configured to receive the emulsified mixture and produce a new oil;
a water-oil separator configured to divide the new oil from a remaining water; and
a return conduit configured to supply the new oil back to the oil tank.

2. The fuel hydrocarbon manufacturing apparatus of claim 1,
wherein the water treatment tank includes:
a nano-bubble generator submerged in the water inside the water treatment tank to provide nano-bubble to the water;
a first carbon dioxide generator configured to generate carbon dioxide gas and provide carbon dioxide gas to the water inside the water treatment tank through the nano-bubble generator; and
an oxygen generator configured to generate oxygen gas and provide oxygen gas to the water inside the water treatment tank;

3. The fuel hydrocarbon manufacturing apparatus of claim 1,
wherein water inside the water treatment tank initially received from outside a water source is treated by a reverse osmosis purifier and the minerals dissolved in the water are removed before entering to the water treatment tank.=

4. The fuel hydrocarbon manufacturing apparatus of claim 1,
wherein the inline mixer includes:
an inline water mixer having a multiple number of protrusions on an inner surface thereof in order to produce turbulence in the water passing through an activated water input line;
an inline oil mixer having a multiple number of protrusions on an inner surface thereof in order to produce turbulence in the oil passing through an oil input line; and
an inline water-oil mixer that generates turbulences in the water and the oil passing through a water-oil mixture line.

5. The fuel hydrocarbon manufacturing apparatus of claim 4,
wherein the inline water-oil mixer includes:
a second carbon dioxide generator configured to provide carbon dioxide gas into the emulsified mixture.

6. The fuel hydrocarbon manufacturing apparatus of claim 1,
wherein the plurality of UV light lamps is inserted at the center of inside the plurality of quartz tubes respectively.

7. The fuel hydrocarbon manufacturing apparatus of claim 1,
wherein a ratio between an inflow rate of the activated water and an inflow rate of the oil supplied into the emulsion tank is 1:1

8. The fuel hydrocarbon manufacturing apparatus of claim 1,
wherein the reactor tank includes:
a third carbon dioxide generator configured to provide carbon dioxide gas into the reactor tank;
a carbon dioxide spraying rod vertically connected to the carbon dioxide generator and extruded inside the reactor tank;
A plurality of spraying nodes located along the carbon dioxide spraying rod; and
a plurality of spraying nozzles attached onto the plurality of spraying nodes.

9. The fuel hydrocarbon manufacturing apparatus of claim 8,
wherein the reactor tank is previously filled with carbon dioxide gas through the third carbon dioxide generator using the plurality of spraying nozzles with the inside pressure of the reactor tank to be 0.4-1.0 MPa before the emulsified mixture comes inside.

10. The fuel hydrocarbon manufacturing apparatus of claim 1, further comprising:
an emulsion line connecting the emulsion tank and the reactor tank;
An emulsion feeding pump installed on the emulsion line and feeds the emulsified mixture from the emulsion tank to the reactor tank.

11. The fuel hydrocarbon manufacturing apparatus of claim 10,
wherein the pressure of the emulsion feeding pump is set to 7.0-8.0 MPa.

12. The fuel hydrocarbon manufacturing apparatus of claim 1,
wherein the reactor tank includes:
an agitator attached at the center of inside the reactor tank.

13. The fuel hydrocarbon manufacturing apparatus of claim 12,
wherein the agitator rotates vigorously for 4-5 minutes during reaction between the emulsified mixture and carbon dioxide gas inside the reactor tank.

14. The fuel hydrocarbon manufacturing apparatus of claim 1,
wherein the reactor tank includes:
a heating pad attached on the side of the reactor tank.

15. The fuel hydrocarbon manufacturing apparatus of claim 14,
wherein the heating pad maintain constant temperature in the range of 30-33 degree Celsius inside the reactor tank.

16. A fuel hydrocarbon manufacturing method, comprising:
preparing the activated water by providing purified water into the water treatment tank;
storing the activated water in the water tank;
storing the oil in the oil tank;
supplying the activated water and the oil to the inline water mixer and the inline oil mixer individually to create the emulsified mixture;
supplying carbon dioxide gas through the inline water-oil mixer;
storing the water-oil mixture to the emulsion tank;
preparing carbon dioxide gas inside the reactor tank;
supplying emulsified mixture to the reactor tank;
agitating the emulsified mixture inside the reactor tank;
separating the new oil from the remaining water by the water-oil separator; and
returning the new oil to the oil tank.

17. The fuel hydrocarbon manufacturing method in claim 17, further comprising:
supplying nano-bubble carbon dioxide gas into the water inside the water treatment tank;
supplying oxygen gas into the water inside the water treatment tank; and
circulating the water to the titanium dioxide coated ceramics irradiated by UV light.
